(19) United States
(12) Patent Application Publication
(10) Pub. No.: US 2006/0161627 A1
(43) Pub. Date: Jul. 20, 2006

(54) System and method for verifying and archiving electronic messages

(76) Inventor: Alexander M. Bradbury, Aventura, FL (US)

Correspondence Address: CHRISTOPHER J. CAPELLI, ESQ., 2 SUZANNE LANE, CHAPPAQUA, NY, 10514, US

(21) Appl. No.: 11/035,982

(22) Filed: Jan. 14, 2005

(51) Int. Cl. G06F 15/16

(52) U.S. Cl. 709/206

(57) ABSTRACT

The present invention relates to a method and system for certifying the transmission of an electronic document that is being transmitted from a sender's electronic device to a recipient's electronic device wherein the electronic document contains at least a header portion containing addressing information and a body portion. A first identifier is determined that is representative of at least a portion of the body portion of the electronic document to be sent and a separate second identifier is determined that is representative of at least a portion of the body portion of the aforesaid electronic document. These identifiers are then stored and after the document is transmitted to a recipient, a third identifier is determined that is representative of at least a portion of the header portion of the electronic document received on the recipients' electronic device and a fourth identifier is determined that is representative of at least a portion of the body portion of the electronic document received on the recipients' electronic device. If the third and fourth identifiers are respectively the same as the first and second identifiers stored in the database then certification for the electronic document is provided.

### I. TECHNICAL FIELD

This invention relates generally to the field of computer data security, and more particularly, to security for electronic mail messages.

### II. BACKGROUND OF THE INVENTION

The widespread use of electronic mail (e-mail) and groupware applications coupled with the growth and ubiquity of the Internet have opened new avenues for business level communications and electronic commerce. Organizations are increasingly relying on e-mail for the transfer of critical files such as purchase orders, sales forecasts, financial information and contracts both within the organization and increasingly with other organizations via the Internet. In this setting, these files are now tangible information assets that must be protected.

A number of conventional security measures exist to insure the confidentiality and integrity of modern data communications. For example, traditional firewalls prevent network access by unauthorized users. Secure sockets technology allows for data to be passed securely over the World Wide Web (WWW). E-mail, however, which is by far the most prominent application over the Internet, still remains problematic, from a security standpoint, for most organizations. Traditionally, firewalls are used to provide such security, but firewalls simply limit access to information protected by the firewall and do not contain the capability to limit transfer of information, into or out of an organization, by way of e-mail. This can lead to inadvertent or deliberate disclosure of confidential information from e-mail originating within an organization and introduction of viruses from e-mail entering an organization.

One solution to protecting confidentiality of e-mail messages is by encrypting such messages. Further security is available by way of digital signatures, which provide for authentication of e-mail messages. Encryption and authentication are both supported in the S/MIME (Secure/Multipurpose Internet Mail Extensions) messaging protocol defined in documents generated by the Internet Engineering Task Force (IETF) entitled “S/MIME Message Specification” (1997) and “S/MIME Certificate Handling”(1997). Individual users can encrypt/decrypt and authenticate e-mail messages using commercially available software. However, the use of software to perform such tasks is not always simple and therefore can detract from the inherent ease of use of e-mail as a means of communication. Moreover, an organization wishing to use such software must rely on individual users to encrypt all necessary messages without means of any centralized control. In addition, many conventional firewalls contain no capability to control the content or format of certain messages that enter or exit an organization.

There is accordingly a need for a system and method that provides for secure e-mail through verifying the authenticity of the e-mail's author and contents which system and method is readily adaptable to existing e-mail structure while overcoming the noted disadvantageous of the prior art attempts for doing so.

### III. SUMMARY OF THE INVENTION

Accordingly the present invention relates to a method and system for certifying the transmission of an electronic document that is being transmitted from a sender's electronic device to a recipient's electronic device, which method and system may be readily adapted to a user's existing e-mail system.

In a preferred embodiment, the present invention relates to a system and method that provides a remote electronic certification device, which is preferably located at a location remote from both the sender's and recipient's respective electronic devices (e.g., personal computers (PC)). Preferably, the remote electronic certification device is also itself a personal computer. In use, when a user desires to compile an e-mail that is to be sent, and subsequently certified, the user's PC establishes at least temporary communication between the user's PC and the remote electronic certification device. The user then proceeds to compile the e-mail message on the user's PC by preferably completing first the header portion, then the body portion of the e-mail message. Pursuant to the ensuing certification process, and prior to transmitting the e-mail message to a recipient, at least a portion of the header portion of the e-mail message is transmitted from the user's PC to the remote electronic certification device. Upon receipt, the remote electronic certification device computes a first identifier (e.g., a first checksum) representative of at least a portion of the header portion of the e-mail being compiled on the user's PC. Preferably next, at least a portion of the body portion of the e-mail message being compiled on the user's PC is transmitted to the remote electronic certification device, and again, preferably prior to the e-mail message being transmitted to a recipient. Again upon receipt, the remote electronic certification device then computes a second identifier (e.g., a second checksum) representative of at least a portion of the body portion of the e-mail message being compiled on the user's PC. The remote electronic certification device then stores these first and second identifiers preferably in a designated electronic file in an associated database of the electronic certification device.

When a user has completed compiling the e-mail message, this e-mail message is then transmitted from the user's PC to a recipient's PC, via conventional e-mail techniques. The recipient then receives this transmitted e-mail at the recipient's PC using the recipient's existing, and preferably non-modified e-mail client (e.g., MICROSOFT OUTLOOK). When the recipient desires to obtain certification for the received e-mail message, at least temporary communication is established between the recipient's PC and the remote electronic device, preferably via a hyper-link provided in the e-mail message. Pursuant to the e-mail certification process, at least a portion of the header portion of the e-mail message received on the recipient's PC is transmitted from the recipient's PC to the remote electronic certification device. Additionally, at least a portion of the body portion of the e-mail message received on the recipient's PC is transmitted to the remote electronic certification device.

Upon receipt of the aforesaid transmitted information from the recipient's PC, the remote electronic certification device computes a third identifier (e.g., a third checksum) representative of at least a portion of the header portion of the e-mail message received on the recipients' PC. Also, the remote electronic certification device computes a fourth identifier (e.g., a fourth checksum) representative of at least a portion of the body portion of the e-mail message received on the recipients' PC. The remote electronic certification device then preferably determines if the aforesaid third and fourth identifiers are respectively the same as the first and second identifiers stored in said remote electronic certification device, which were associated with the aforesaid e-mail transmitted from the user's PC to the recipients PC. If it is determined the first and third identifiers are the same, respectively, as the second and fourth identifiers, then the remote electronic certification device provides certification for the aforesaid e-mail message transmitted from the aforesaid user's PC to the aforesaid recipient's PC. This certification notice may be provided to both the recipient and user.

In essence, this certification provides assurance that the received e-mail was indeed sent from the party it represents to be sent from and the contents of the e-mail message were also not altered, or in any way tampered with, during the transmission from the user's PC to the recipient's PC.

### IV. BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates the processor-based systems of a preferred embodiment of the present invention;

FIG. 2 illustrates a flow chart diagram of a user registering to use of the present invention of FIG. 1;

FIG. 3 illustrates a flow chart diagram illustrating the process of acquiring and generating data necessary for verifying the authenticity of an e-mail in accordance with the present invention of FIG. 1;

FIG. 4 illustrates a flow chart diagram illustrating the process of verifying the authenticity of an e-mail received in accordance with the present invention of FIG. 1; and

FIGS. 5-9 depict flowcharts illustrating another embodiment of the present invention whereupon email messages transmitted from a user to an intended recipient are stored in the remote certification system of the present invention.

### V. DETAILED DESCRIPTION OF THE PREFERRED EMBODIMENT

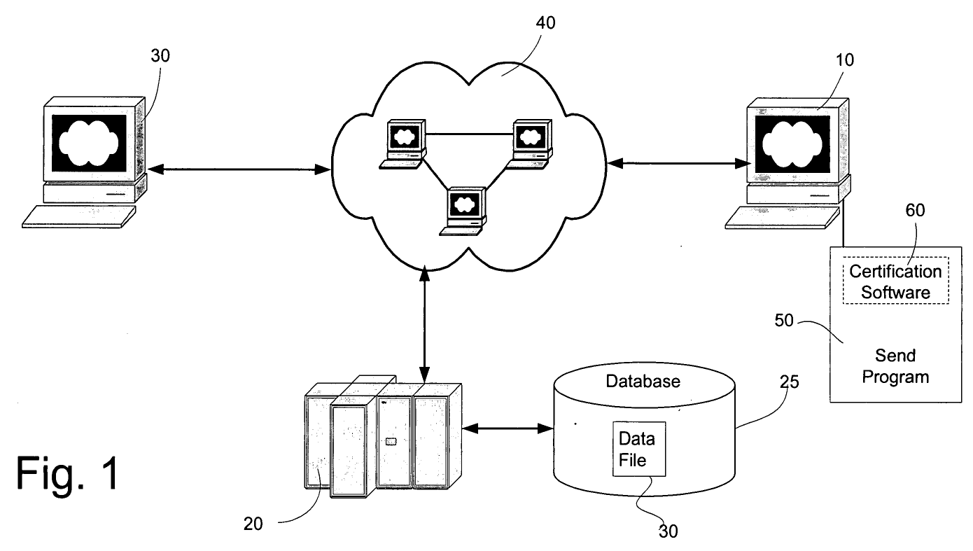

The present invention provides for the general certification of electronic delivery of a transmitted document (e.g., an e-mail message). Although the present invention may be accomplished through varying means, the preferred embodiment of the present invention is described below with reference to FIGS. 1-4.

It is to be appreciated that the system of the present invention operates in conjunction with known e-mail architecture. For instance, it is to be understood that in accordance with the present invention system, e-mail is processed via a Simple Mail Transfer Protocol (SMTP) relay module which performs the functions of a conventional Internet relay host. An example of an Internet relay host is a send mail program, whereupon the SMTP relay module transmits and receives e-mail messages from both internal and external sites. As is conventional, an e-mail message, as described hereunder takes the form of a conventional e-mail message which contains a plurality of user specified information fields, such as source field specifying an e-mail address for the source of the message, a destination field specifying one or more destination e-mail address(es) for the message, a subject field specifying a subject for the message, a body field specifying the body of the message containing textual and/or graphics data, and an attachment field specifying one or more files to be transmitted with the message. Other user specified fields include, but are not limited to, priority of the message, identity of the sending agent and the date and time of the message.

It is to be further appreciated that e-mail messages may be encoded in accordance with one of a plurality of known encoding formats and that the SMTP relay module preferably takes a conventional form of a software module which receives and transmits e-mail messages in accordance with the Simple Mail Transfer Protocol as specified by Internet RFC 821. The SMTP protocol is not critical and may be replaced with a module that receives and/or transmits messages in other formats such as the File Transfer Protocol (FTP) or the Hyper-Text Transfer Protocol (HTTP). The SMTP relay module can preferably be configured to use Domain Name System (DNS) to determine routing to message recipients or alternatively can relay messages to an administrator specified SMTP host. If DNS is selected, a default SMTP host can still be specified to allow a message to be forwarded even if DNS service is not available. Also, it is to be appreciated that the term “INTERNET” is well known in the art as designating a specific global international computer network that operates according to the TCP-IP protocol.

In accordance with the present invention system, a user invokes a first processor-based system (PC) to certifiably transmit a selected document (e.g., an e-mail message) via a program, hereinafter referred to as the “send program”, stored on the first PC. The send program requests input from the user, co-existing process, or coupled devices, about the electronic document to be transmitted, to whom it is to be transmitted, including an electronic address such as e-mail address, level of certification desired, etc. Preferably, the send program consists of a commercially available e-mail client such as OUTLOOK, commercially available from MICROSOFT or LOTUS NOTES, commercially available from IBM. A request for verification and certification is then made to a remote certification device. In the preferred embodiment the remote certification device is itself preferably another PC. Upon verification by the remote certification device, a checksum(s) and/or total bit count(s) is generated by the remote certification device for the e-mail message and additional information provided by the send program such as the recipient's electronic address identification of the sending site, time of document transmission, and number of pages in the document to be transmitted may also be utilized. It shall be understood that any form of summarily indicating the content of the electronic message may be utilized in place of a checksum and/or total bit count if desired. Furthermore, although the following discussion refers primarily to the use of a checksum, it shall be understood that any summary indication of the content of the electronic message in combination with, or in place of, a checksum may advantageously be used.

As will be further described below, a e-mail and its certification link is transmitted by the send program on the registered user's PC to a recipient's PC. In the preferred embodiment, the recipient site is also a PC. Upon receipt of the e-mail, the recipient then communicates with the remote certification PC, preferably via the certification link, to verify the received e-mail against the stored certification information regarding the received e-mail.

Referring to FIG. 1, there are illustrated processor-based systems (PCs) 10, 20 and 30 utilized in the above described preferred embodiment of the present invention. Specifically, PC 10 is utilized to implement the aforementioned send program 50, PC 20 is utilized to implement the certification process required for the e-mail, and PC 30 is utilized to receive an e-mail from the sender's PC 10 and e-mail certification from the remote certification PC 20. It is to be appreciated that PC's 10, 20 and 30 preferably each include a chassis enclosing a processor (CPU) and a media reader/recorder (e.g., disk drive). As such, PCs 10, 20 and 30 are preferably general purpose computers, such as an IBM compatible (or Apple Macintosh) controlled by any general purpose operating system such as DOS or UNIX. It should be noted that PCs 10, 20 and 30 may each be of differing types and/or controlled by different operating systems.

It is to be appreciated that while the below-described illustrative embodiment of the present invention makes reference to electronic devices 10 and 30 as respective PC's, it is to be understood that they may embody any type of device, whether currently known or unknown, that is capable of receiving and/or transmitting electronic messages such as email messages. Examples of current known electronic devices include: cell phones, hand-held email devices, PDA's, etc.

Still referring to FIG. 1, it can be seen that PCs 10, 20 and 30 are preferably linked together through the Internet 40. Connection to one another through the Internet 40 may be accomplished by any means now existing or later developed. Alternatively, PCs 10, 20 and 30 may be linked directly through digital telecommunications trunks (not shown) or through a digital network system (not shown). It shall be understood that in utilizing a digital network system to link PCs 10, 20 and 30, network interface cards (NIC) or other digital communications devices may be utilized, e.g. ISDN. It will be appreciated by those of skill in the art that any network linking PCs 10, 20 and 30 may either be secure or not, depending on the degree of security desired with respect to the transmission of the document to be certified.

With particular reference to PC 10, it is to be understood that its aforesaid send program 50 for compiling and transmitting an e-mail message includes certification software 60, preferably via a plug-in interfacing program in the send program 50, which performs the certification process of the present invention, as will now be described below.

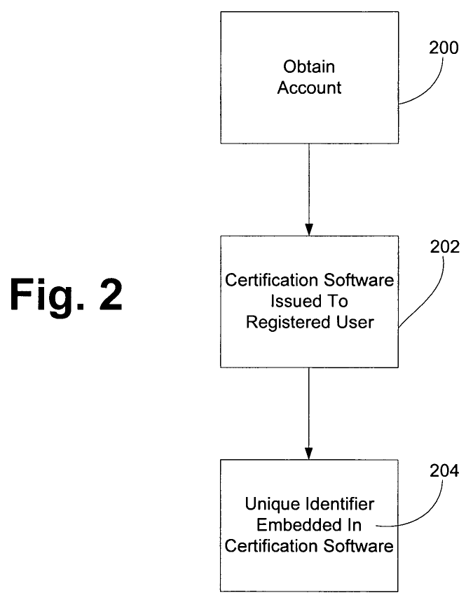

Directing attention to FIGS. 2-4, flow charts depicting the overall operation the system are shown and illustrated in FIG. 1.

First, and with specific reference to the flow chart of FIG. 2, a user preferably establishes an account with the certification service provider of remote certification PC 20 (step 200). Once an account is obtained (preferably thorough proper proof of the user's identification and any affiliations), the service provider of PC 20 issues the user's PC 10 certification software 60 that is to be embedded in the user's e-mail send program 50 (step 202). The e-mail certification software 60 issued to the registered user of PC 10 is preferably unique to that user in that it contains a unique user identifier that is associated preferably with the registered user's e-mail addresses(s) and/or IP addresses (step 204). The unique user identifier may be encrypted within the e-mail certification software 60. For example, a registered user may register the e-mail address marek@buyitnow.com with the certification service system of PC 20, which generates and assigns a unique identifier 112233 to be associated with the user's registered email address of marek@buyitnow.com as well as the registered user's IP address used for this e-mail address (marek@buyitnow.com). This identifier (e.g., 112233) is then preferably embedded in the e-mail certification software 60 issued to the registered user 10.

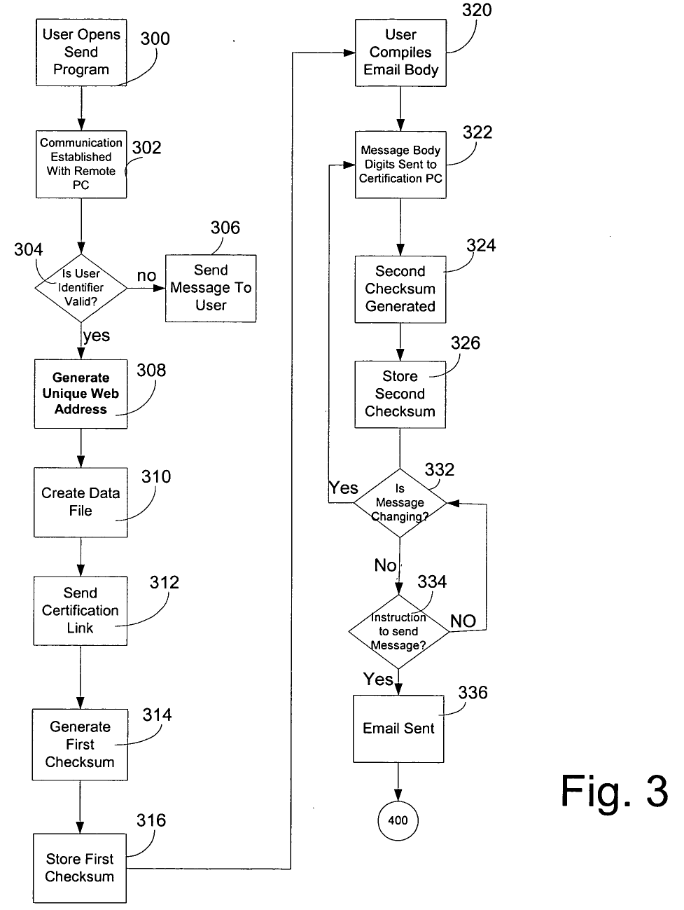

With reference now to FIG. 3 and starting with a registered user desiring to compile and transmit a certified e-mail message, the user activates the send program 50 on PC 10, which preferably also automatically activates the embedded certification software 60 (step 300). It shall be appreciated by one of skill in the art that the send program 50 and certification software 60 may be executed in the form of a terminate and stay resident (TSR) program and therefore allow for the automatic association by send program 50 of a document created within a co-executing process. In a preferred embodiment, the send program 50 is capable of execution in a multi-tasking environment, such as the MICROSOFT WINDOWS operating environment, therefore providing the ability to select and transmit an electronic document created in a co-executing process as well as to integrate a received certification indicia within the original electronic document.

At step 302 the send program 50, and particularly certification software 60, establishes communication between the user's PCs 10 and the remote certification PC 20, preferably via Internet 40. Preferably, during this communication the certification software 60 causes the unique identifier embedded within it (e.g., 112233) to be sent from the user's PC 10 to the remote certification PC 20.

The communication established in step 302 is suitable for data communications between PCs 10 and 20. In the preferred embodiment, communication step 302 includes the sub-steps of establishing data communications between the sender's PC's 10 and the remote certification PC 20, and as to providing information as to which resource available through the data communications access is to be utilized, and verifying that data communications with a document transmission certification system has been accomplished. It shall be understood that there is no limitation of the present invention to establish and terminate the communications link between the sender's PCs 10 and the remote certification PC 20. For example, where digital telecommunications trunks (not shown) or a digital network system (not shown) are utilized for linking PCs 10 and 20, a data communication link may advantageously be maintained for extended periods of time thereby eliminating the need for the send program 10 to establish and terminate the communications link.

Upon receipt of the users unique identifier (e.g., 112233), the remote certification PC 20 determines whether the transmitted unique identifier (e.g., 112233) is a valid registered user of the certification system of PC 20 and does it match properly with the associated user's e-mail address (e.g., marek@buyitnow.com) (step 304). If the user's transmitted unique identifier is not valid or does not properly match with the user's registered e-mail address, a message is sent to the user's PC 10 that this message cannot be certified by the remote certification system PC 20 (step 306). This message can occur through a dialog box or any other known means of providing a message from remote certification system 20 to the sender's PC 10.

If the user's unique identifier (e.g., 112233) is both valid and matches with the user's registered e-mail address (e.g., marek@buyitnow.com), the remote certification system PC 20 preferably generates a unique web address (e.g., www.microsentry.com/unique1) that is to be associated with the certification for this e-mail as described further below (step 308). Preferably, this unique address has a data file 30 associated with it in a database 25 associated with the remote certification PC 20, as also further described below (step 310).

The remote certification PC 20 then generates a certification web link, which is a web link to the aforesaid unique web address (e.g., marek@buyitnow.com/unique1). This web link also preferably contains software instruction causing an executing PC to forward the contents of the attached e-mail to the remote certification PC 20, again as will also be further explained below. This web link is then sent from the remote certification PC 20 to the user's PC 10 so as to be attached to preferably the footer portion of the e-mail being compiled on the user's PC 10 (step 312). In the preferred embodiment, if the send program 50 on the user's PC 10 is compiling a plain text email, the certification software 60 includes the web link as plain text. And if the send program 50 is compiling an HTML e-mail, the certification program 60 includes the web link as a graphic (e.g., a logo) in the e-mail. In either event, the aforesaid web link or graphic provides a web link directly to the remote certification system PC 20 when clicked upon by a recipient 30 of the e-mail, as will be explained further below.

When the user of PC 10 completes the addressing portions of the e-mail message in the e-mail send program 50 (e.g., To: gmchin@bidchat.com and From: marek@buyitnow.com) the certification software 60 preferably sends this information to the remote certification PC 20 to generate a first checksum representative of the digits contained in the header of the e-mail step 314. The remote certification system PC 20 also preferably stores this first checksum in the file 30 created in step 310 for this e-mail having the aforesaid prescribe unique web address (e.g., www.microsentry.com/unique1) (step 316)

The user then preferably proceeds to compile the body of the e-mail message whereupon as the user compiles each digit of the message body (step 320), each such digit is sent to the remote certification system PC 20, via certification software 60 and internet 40 (step 322). Upon receipt of each aforesaid message body digit, the remote certification system PC 20 generates a second checksum representative of the message body of the e-mail being compiled on the user's PC 10 (step 324). This second checksum is then automatically stored in the electronic file 30, along with the first checksum, associated with the aforesaid unique address (www.microsentry.com/unique1) created in step 314 (step 326).

As the user of PC 10 continues to change the digits in the message body of the e-mail (step 332), this change in digits is preferably instantly sent back to the remote certification system PC 20, via certification software 60 and Internet 40 whereupon steps 320 to 326 are repeated (step 332). Thus, as the user of PC 10 continues to alter the digits in the body of the e-mail, the second check sum stored in the file 30 of database 25 (in step 326) correspondingly changes.

A determination is then made in step 334 as to whether the e-mail message was sent from the user's PC 10, via send program 50 and Internet 40, to the intended e-mail recipient at PC 30 (e.g., gmchin@bidchat.com). If no, then the aforementioned determination is repeated at step 332 as to whether any of the digits of the e-mail being compiled on the user's PC 10 have changed. If yes (the e-mail was transmitted from the user's PC 10), then the certification program 60 preferably indicates to remote certification system PC 20 that the e-mail has been completed and transmitted to the intended recipient and this is preferably indicated in the file 30 in database 25 along with the time the e-mail was sent, which file was created at step 310 for this e-mail (step 336). Hence, what is preferably stored in the file 30 in database 25 is: the first checksum (indicative of the header information of the e-mail); the second checksum (indicative of the message body for the e-mail) and preferably the time the e-mail was transmitted from the user's PC 10.

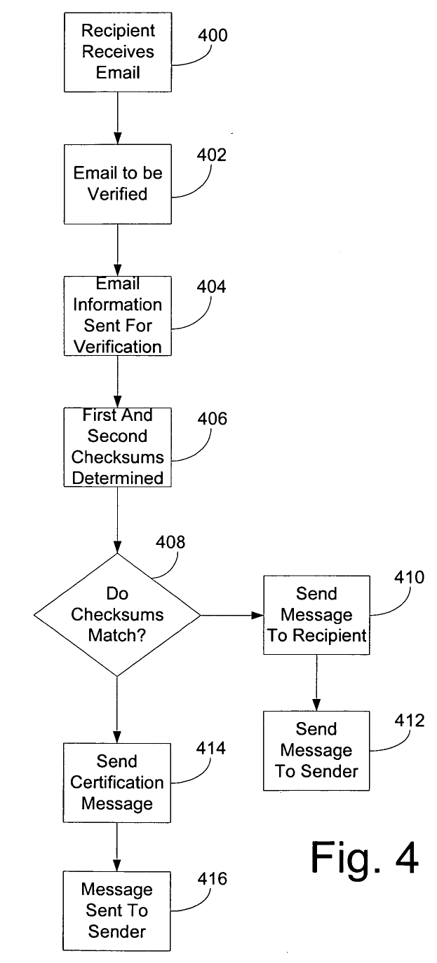

With reference now to FIG. 4, the process of receiving and verifying a certified e-mail will now be discussed. Starting at step 400, the recipient (e.g., gmchin@bidchat.com) at PC 30 receives the aforesaid e-mail transmitted from the sender's PC 10 with an e-mail client used by the recipient (e.g., Lotus Notes or Microsoft Outlook). It is noted that the recipient 30 does not need any software associated with the remote certification PC 20 (e.g., certification software 50) to receive and verify the e-mail. The e-mail is preferably viewed as an ordinary e-mail having the aforesaid certification link. To verify the authenticity of the e-mail, the recipient preferably clicks (e.g., selects) the aforesaid certification web link included in the e-mail as discussed above in step 312 with reference to FIG. 3(step 402). This selection of the certification link preferably instructs its embedded software to cause the default browser of the recipients PC 30 to activate so to forward the contents of the e-mail (e.g., including the e-mail header and body information) to be sent to the designated web address (e.g., www.microsentry.com/unique1) in the remote certification PC 20 (step 404). Upon receipt of this information, the remote certification PC 20, calculates a first checksum for the received header information and a second checksum for the received body information (step 406). The remote certification PC 20 then compares these calculated first and second checksums to what was stored in the file 30 of the database 25 associated with the aforesaid designated web address (e.g., www.microsentry.com/unique1) (step 408). If they do not match, a message is preferably sent from the remote certification PC 20 to the recipients PC 30 that this message cannot be verified (step 410). A message may also be sent to the registered sender of the e-mail (e.g., sender's PC 10) that an e-mail message was received by a recipient at PC 30 but could not be verified (step 412). It is noted that the message sent to the recipient's PC 30 and/or sender's PC 10 can either be generic (e.g., indicating only that the message could not be verified) or detailed as to the reason why it could not be verified (e.g., an unauthorized change occurred in the header portion of the e-mail).

If a match of the first and second checksums is found in step 408, then a message is sent to the recipient's PC 30 indicating that the e-mail can be verified as being sent from the registered sender (e.g., marek@buyitnow.com) and that neither the header or body portion of the e-mail was altered during transmission from the sender's PC 10 (step 414). Additionally, a message may also be sent to the registered sender of the e-mail (e.g., sender's PC 10) that the e-mail message was received at a specified time and date and was able to be properly verified (step 416). Thus, this is analogous to a return receipt of the e-mail sent.

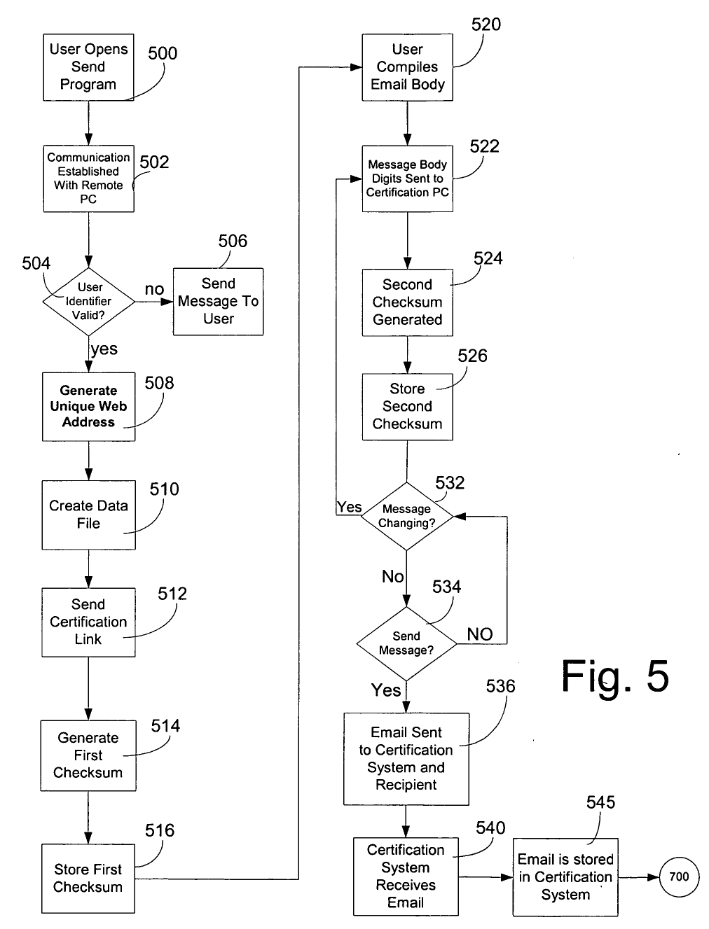

With reference to FIGS. 5-7 another embodiment of the present invention will now be described. Briefly stated, in these embodiments, when an email is completed by a registered user at PC 10, in addition to the email message being transmitted to an intended recipient at PC 30 as described above, a copy of this email message is additionally transmitted to remote certification system 20 for storage (e.g., archival) therein, which will now be discussed below.

With specific reference now to FIG. 5, it is to be understood that steps 500-534 are substantially similar to corresponding steps 300-334 of FIG. 3 as described above. Thus, the above descriptions of steps 300-334 are to be understood to be descriptive of respective steps 500-534 in FIG. 5. Hence with specific reference to step 536 of FIG. 5, when a registered user at PC 10 utilizes its send program 50 to transmit a compiled email message to an intended recipient (e.g., PC 30), the send program 50, preferably via instructions from embedded certification software 60, also causes a copy of this compiled email message to be transmitted to remote certification system 201. Next, and as mentioned above, in addition to an intended recipient (e.g., PC 30) receiving the transmitted email message, via step 536, a copy of this email message is also transmitted to and received at remote certification system 20, step 540. Next, preferably this copy of the email message is stored in the aforesaid database 25 associated with remote certification system 20, step 545. Preferably the aforesaid email message is stored in the above-described data file 30 that was created via step 310 having the unique web address (i.e., www.microsentry.com/unique1) for this email message (step 545). It is to be appreciated that the email message is then preferably stored in its associated file created for it (www.microsentry.com/unique1) along with the determined first and second identifiers (steps 516 and 526) for the email message and the registered user's unique identifier (e.g., 112233) (step 204).

It is to be appreciated that email messages stored in data file 30 of database 25 may be stored therein for a predetermined amount of time as preferably determined by a registered user 10. For instance, when a user 10 establishes an account with remote certification system 20, user 10 may prescribed that an email message may only be stored in remote certification system 20 for a period of thirty days, after which it will be automatically deleted from remote certification system 20. Thus, a user may prescribe a time period (e.g., thirty days) generally for preserving all the user's e-mail's that are copied onto remote certification system 20 before they are automatically deleted therein. Still further, a registered user 10 may prescribe a specific time period (e.g., 2 days) that applies only to a specific email that is archived within remote certification system 20, which specific time period differs from, and thus overrides, that of the aforesaid generally prescribed time period (e.g., thirty days). Still further, a user 10 may override any prescribed parameters for deleting email messages so as to immediately delete messages stored in remote certification system 20.

It is noted that a purpose for maintaining an archival database of email messages sent from a registered user 10 in remote certification PC 20 is for providing an email archival database that is accessible to registered users. In other words, so long as an email message has not been deleted from the remote certification system 20, a registered user may log onto, via preferably the internet, the remote certification system 20 to retrieve copies of email messages that were previously transmitted in step 536. For instance, if a user 10 on Oct. 1, 2004 sent an email message to steve@gmchin.com, that user 10 may then log onto remote certification system 20 at a later date (e.g., Oct. 10, 2004) and retrieve a copy of that email message regardless of whether that email was stored locally on the user's PC 10. (and assuming that the remote certification system 20 was not prescribed to delete this message by the date the user's desires to retrieve a copy of it). Since email messages are preferably stored in remote certification PC 20 along with the registered user's unique identifier (e.g., 112233), when a registered user 10 logs onto system 20 with its unique identifier (e.g., 112233) all stored email messages also having that unique identifier (e.g., 112233) may then be presented to the user 10 upon the user's demand.

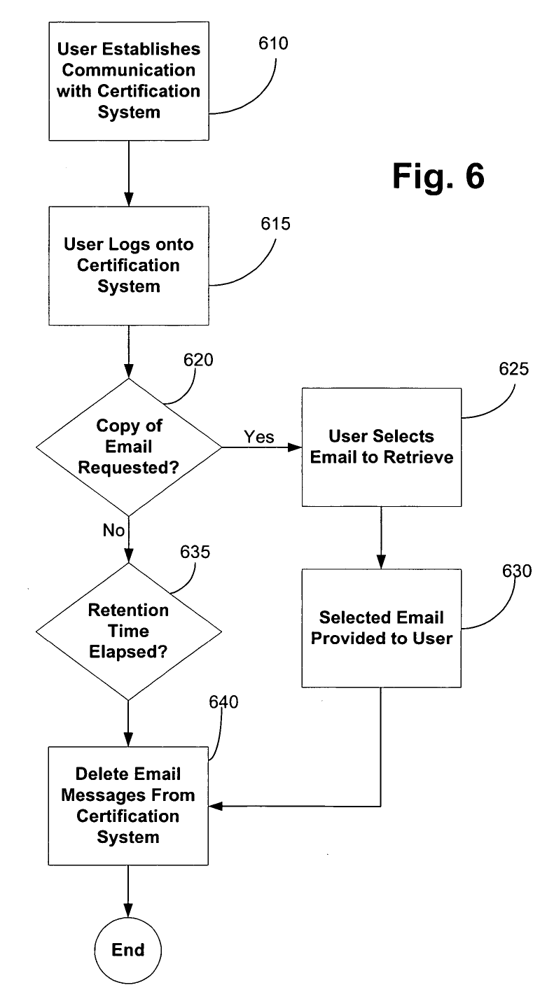

With reference now FIG. 6, when a registered user 10 desires to retrieve archived copies of email messages that are stored in system 20, the user 10 preferably first establishes remote communication with certification system 20, preferably via known internet protocols, step 610. It is of course to be appreciated that a user 10 may establish bi-lateral data communication with certification system 20 through any known means of accomplishing the desired type of communication. After this communication is established, the user 10 then preferably logs onto certification system 20 preferably using the user's unique identifier (e.g., 112233), step 615. A determination is then made in remote certification system 20 as to whether a user 10 is requesting to obtain a stored copy of an email message that was previously sent from the user and stored in system 20, step 620. If yes, then the certification system 20 preferably presents to the user 10 email messages that are stored within its associated database 25 and which were sent from the registered user 10. Again, preferably the registered user's assigned unique identifier (e.g., 112233) preferably provides the nexus between the user 10 and email messages stored within database 25 that were previously sent from the user 10, step 625. It is to appreciated that email messages stored in certification system 20 that are associated with a registered user 10 may be presented to the user 10 in a number of formats such as: chronological order as to when the message was transmitted, according to who the intended recipient was; the remark line, message length, message contents, etc. Once a user 10 selects the message(s) that is desired to be retrieved from step 625, the certification system 20 then causes those selected email message(s) to be transmitted and/or presented to the user 10 through any known means of accomplishing such a task, which tasks of actually sending and presenting are certainly well known to one skilled in the art, step 630.

Preferably next, at step 635 a determination can then made as to whether the user 10 desires to delete any stored messages in certification system that are associated with the registered user 10 as discussed above. If yes, a user 10 can then select which stored message(s) are to be deleted from certification system 20, and after this selection is made, the deletion of those selected email message(s) is performed, step 640.

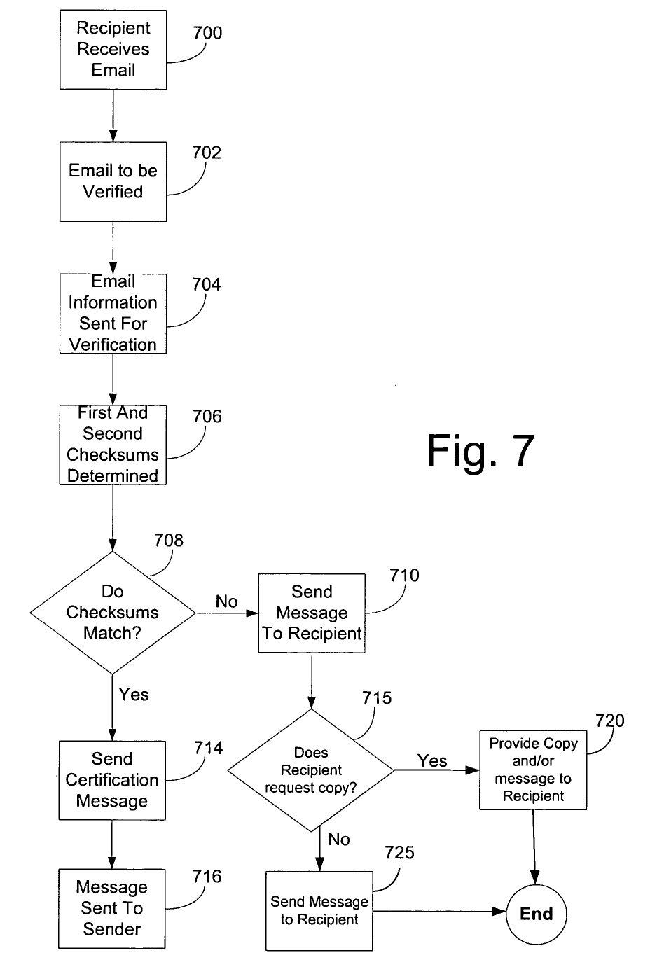

With reference to FIG. 7, another advantage of archiving transmitted copies of email messages as discussed above with reference to FIGS. 5 and 6 will now be discussed. It is to be understood that steps 700-716 are substantially similar to corresponding steps 400-416 of FIG. 4 as described above. Thus, the above descriptions of steps 400-416 are to be understood to be descriptive of respective steps 700-716 in FIG. 7. With specific reference now to step 715, after an email message has been received by a recipient 30 (steps 700-706) and cannot be properly verified by certification system 20 (step 708), and after a message stating this situation has been sent to the recipient 30 (step 710) and sender 10 (step 712), a determination may then be made by the recipient 30 as to whether the recipient 30 desires to receive and/or view a copy of the actual email message that was sent from the sender 10 to the recipient 30, step 715. If yes, then a copy of this stored email message is made available to the recipient 30 from certification system 20, step 720. Thus, the recipient 30 may then compare the email message that was received from the sender 10 to that which was stored in certification system 20 to determine what the differences are. It is to be appreciated that step 720 may automatically perform this service to the recipient 30, and user 10, whereby the certification system 20 will precisely identify the portions of the email which were altered during the e-mail's transmission from the registered user 10 to the intended recipient 30 (step 334). This service can be performed by certification system 30 through comparing the email message that was received from the sender 10 to that which was stored in certification system 20. These identified differences may then be sent to both the recipient 30 and user sender 10.

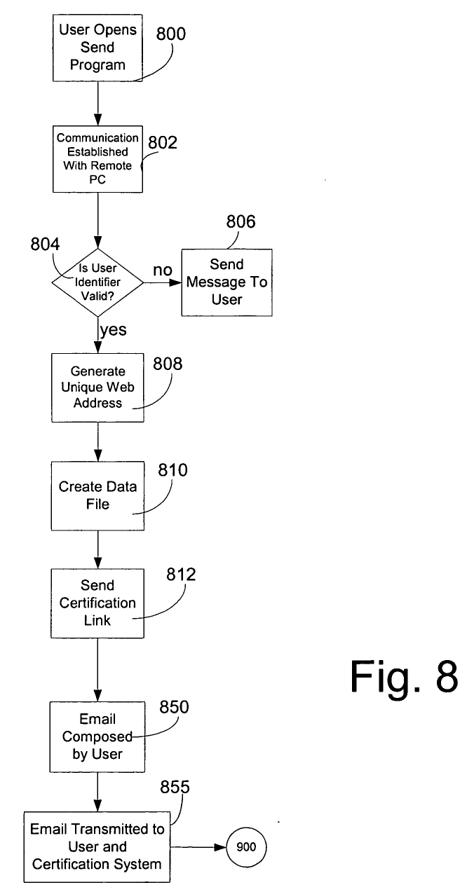

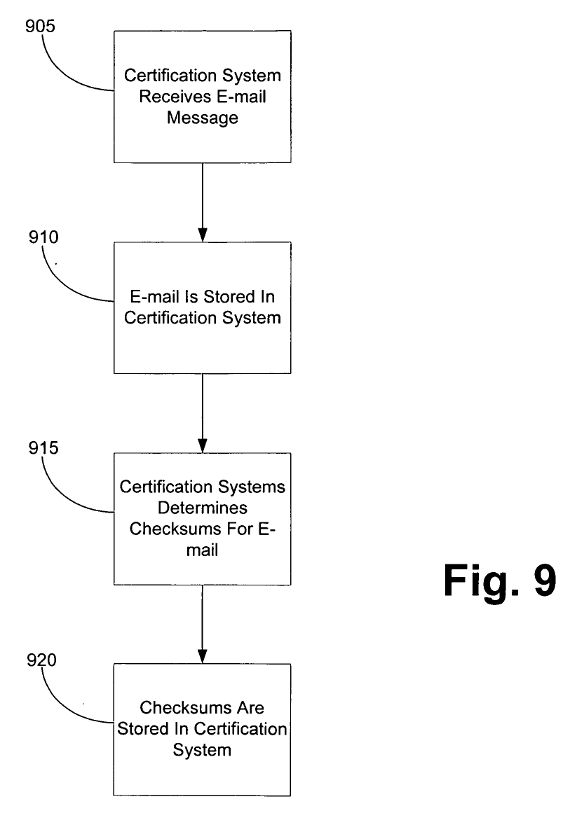

With reference to FIGS. 8 and 9, another embodiment of the present invention will now be discussed regarding again the storing (e.g., archiving) of email messages in the certification system 20 that were transmitted from a user 10 to an intended recipient 30. It is to be understood that steps 800-812 are substantially similar to corresponding steps 300-312 of FIG. 3 as described above. Thus, the above descriptions of steps 300-312 are to be understood to be descriptive of respective steps 800-812 in FIG. 8. With specific reference now to step 850, after the certification link has been generated in certification system 20 and sent to the user's PC 10 so as to be embedded in the email being compiled by the user (preferably via certification software 60) (step 812) the email will then be continued to be composed by a user with preferably the certification link already embedded in it, step 850. It is to be appreciated that the certification link may be embedded in the email after it is fully composed by a user and upon instructions to the send program 50 to transmit the email to an intended recipient 30. Next, the email is then sent from the user's PC 10 to an intended recipient 30 with the certification software 60 preferably instructing the send program to also send a copy of that email to the certification system 20, step 855. Thus, it is noted that in distinction to the process described in FIG. 3 depicting sending an email from a user 10, in the process depicted in FIG. 8, no checksums are determined prior to an email being transmitted from a registered user 10 to an intended recipient 30. The determination of email checksums will now be discussed below with reference to FIG. 9.

With attention now to FIG. 9, in step 905 the certification system 20 receives a copy of the email sent from a registered user's PC 20 to an intended recipient's PC 30 (step 855). The received email is then stored in preferably the database 25 associated with certification system 20, and preferably in a data file 30 identified by the unique web address (e.g., www.microsentry.com/unique1) generated for that email (step 308), step 910. A first checksum is then determined that is representative of digits contained in the header portion of the aforesaid received email message, and likewise, a second checksum is determined that is representative of digits contained in the body portion of the aforesaid received email message, step 915. It is to be appreciated that the aforesaid first and second checksums may also be determined after the aforesaid email is received by certification system 20 but prior to the received email being stored in a database 25 associated with the certification system 20. These determined first and second checksums are then stored in association with the email message they are representative of in preferably the database 25 associated with certification system 20, and preferably in the data file 30 identified by the unique web address (e.g., www.microsentry.com/unique1) generated for that email (step 308), step 920. Thus, and again in distinction to the process depicted in FIG. 3, the verifying checksums for the email message are determined after the email has been sent from a user 10, which process for determination fully occurs in the certification system 20. Thus, an advantage of this arrangement is that the bi-lateral communication between a registered user's PC 10 and the certification system 20 is not hindered by the determination of the verifying checksums representative of an email sent from a user 10 since the checksums are determined in the certifications system 20 after the email has been transmitted from a registered user 10.

In an alternative embodiment of the present invention as described above with reference to FIG. 9, the aforesaid verifying first and second checksums are determined upon the recipient 30 verifying the authenticity of the received email as discussed above with reference to FIG. 4. That is, until the recipient 30 indicates to the certification system 20 (preferably via “clicking upon” the certification link embedded in the received email), that a received email is to be authenticated (steps 402 and 404), the certification system 20 does not perform the step of generating the verifying checksums for email messages that are preferably stored in its associated database 25. It is only after the certification system 20 receives notice from an intended recipient 30 that the notifying intended recipient 30 desires to authenticate the received email message. Once this verification notice is received in certification system 20 (e.g., steps 402 and 404 of FIG. 4) the certification system 20 then retrieves the applicable email message stored in its databases 25, afterwhich a first checksum is determined that is representative of digits contained in the header portion of the aforesaid received email message, and likewise, a second checksum is determined that is representative of digits contained in the body portion of the aforesaid received email message. These determined first and second checksums are then compared against the first and second checksums associated with the email received by the intended recipient (e.g., steps 406 to 416 of FIG. 4).

Furthermore, it is to be understood that while the invention has been described above in reference to generating first and second checksums for verifying the authenticity of an email transmitted from a user, it is to be appreciated that the invention may likewise operate by generating only a single checksum. This single checksum may be representative of all the digits of contained in an email, only a portion of the email digits, a combination of the digits contained in the header and body portion of an email, etc. Thus, the above steps concerning first and second checksums would be performed then only with respect to a single checksum value.

Although the present invention and its advantages have been described in detail, it should be understood that various changes, substitutions and alterations can be made herein without departing from the spirit and scope of the invention as defined by the appended claims.

What is claimed is:

1. A method for verifying the transmission of an electronic document transmitted from a sender's electronic device to a recipient's electronic device, said method comprising the steps of:
determining a first identifier that is representative of at least a first portion of the electronic document provided on the sender's electronic device;
storing the first identifier in a database;
transmitting the electronic document from the sender's electronic device to at least the recipient's electronic device and the database;
receiving the electronic document at the recipient's electronic device and the database wherein the electronic document is stored in the database in association with the determined first identifier;
determining a second identifier that is representative the first portion of the electronic document received on the recipients' electronic device;
determining if the second identifier is the same as the first identifier stored in the database; and
providing notification to the recipient's electronic device if the second identifier is the same as the first identifiers stored in the database.

2. A method as recited in claim 1 wherein the electronic document consists of an e-mail message.

3. A method as recited in claim 1 wherein the electronic device for each of the sender and recipient consist of a Personal Computer.

3. A method as recited in claim 1 wherein the database is located remotely from the recipient's electronic device.

4. A method as recited in claim 3 wherein the database is located remotely from the sender's electronic device.

5. A method as recited in claim 4 wherein the step of transmitting the electronic message from the sender's electronic device includes the step of a sender instructing the sender's electronic device to transmit the electronic document to the recipient's electronic device and the sender's electronic device transmits the electronic document to the database without instruction from the sender.

6. A method as recited in 4 wherein the step of determining the first identifier includes determining a third identifier representative of a second portion of the electronic document and storing the third identifier in the database, the step of determining the second identifier includes the step of determining a fourth identifier representative of the second portion of the electronic document received on the recipient's electronic device, the step of determining if the second identifier is the same as the first identifier stored in the database further includes the step of determining if the fourth identifier is the same as the third identifier stored in the database, and the step of providing notification to the recipient's electronic device includes the step of providing the notification if the second and fourth identifiers are respectively the same as the first and third identifiers stored in the database.

7. A method as recited in claim 6 wherein the electronic document contains at least a header portion containing addressing information and a body portion wherein the first portion of the electronic document corresponds to the header portion and the third portion of the electronic document corresponds to the body portion.

8. A method as recited in claim 7, wherein:
the first identifier is a checksum representative of said at least a portion of the header portion of the electronic document provided on the sender's electronic device;
the third identifier is a checksum representative of said at least a portion of the body portion of the electronic document provided on the sender's electronic device;
the second identifier is a checksum representative of said at least a portion of the header portion of the electronic document received on the recipients' electronic device; and
the fourth identifier is a checksum representative of said at least a portion of the body portion of the electronic document received on the recipients' electronic device.

9. A method as recited in claim 8, further including the steps of:
providing a remote electronic verification device remote from said sender's and said recipient's electronic devices, said remote electronic device containing said database;
establishing at least temporary communication between the sender's electronic device and the remote electronic verification device;
transmitting said at least a portion of the header portion of the electronic document on the sender's electronic device to the remote electronic device; and
transmitting said at least a portion of the body portion of the electronic document on the sender's electronic device to the remote electronic device; and
determining in said remote electronic device said first and third identifiers respectively based upon said transmitted header and body portion of said electronic document from said sender's electronic device.

10. A method as recited in claim 9, further including the steps of:
establishing at least temporary communication between the recipient's electronic device and the remote electronic verification device;
transmitting said at least a portion of the header portion of the electronic document on the recipient's electronic device to the remote electronic device;
transmitting said at least a portion of the body portion of the electronic document on the recipient's electronic device to the remote electronic device;
determining in said remote electronic device said second and fourth identifiers based upon said transmitted header and body portion of said electronic document from said recipient's electronic device; and
determining in said remote electronic device if the second and fourth identifiers are respectively the same as the first and third identifiers stored in the database.

11. A method as recited in claim 10, further including the step of:
providing a copy of the electronic document stored in the database to the recipient if it is determined that the second and fourth identifiers are determined not respectively the same as the first and third identifiers stored in the database.

12. A method as recited in claim 10, further including the steps of:
determining the differences in the remote electronic device between the electronic document stored in the database with that of the electronic document received by recipient if the second and fourth identifiers are determined not respectively the same as the first and third identifiers stored in the database; and
providing notification of the determined differences to the intended recipient.

13. A method as recited in claim 10, further including the step of a user remote from said remote electronic device establishing electronic communication with said remote electronic device to selective gain access to documents stored in said database.

14. A method for verifying the transmission of an electronic document that is transmitted from a sender's electronic device to a recipient's electronic device, said method comprising the steps of:
providing a remote electronic certification device remote from both said sender's and recipient's respective electronic devices;
establishing at least temporary communication between the sender's electronic device and the remote electronic certification device;
providing a link to said sender's electronic device from said remote electronic device associating said electronic document being compiled on said sender's electronic device with a file created in said remote electronic device for said electronic document being complied on said sender's electronic device;
embedding said link in said electronic document being compiled on said sender's electronic device;
transmitting the electronic document from the sender's electronic device to the recipient's electronic device and the remote electronic device;
receiving the electronic document at the recipient's electronic device and the remote electronic device;
storing the electronic document in the remote electronic device in association with the file created for said electronic document in said remote electronic device;
determining a first identifier representative of at least a portion of the electronic document transmitted from sender's electronic device to the recipient's electronic device;
storing in said remote electronic certification device the first identifier;
establishing at least temporary communication between the recipient's electronic device and the remote electronic device via a said recipient activating said link embedded in said electronic document;
determining a third identifier in said remote electronic certification device that is representative of at least a portion of the electronic document received on the recipients' electronic device;
determining in said remote electronic certification device if said second identifier is the same as said first identifier stored in the remote electronic certification device; and
providing certification from said remote electronic certification device for the electronic document transmitted to the recipient's electronic device if the second identifier is the same as the first identifier stored in the remote electronic device.

15. A method as recited in claim 14 wherein the electronic document consists of an e-mail message and the electronic device for each of the sender and recipient consist of a Personal Computer.

16. A method as recited in claim 14 further including the step of:
determining the first identifier in the remote electronic device after the electronic document is transmitted from the sender's electronic device and stored in the remote electronic device.

17. A method as recited in claim 14 further including the step of:
determining the first identifier in the remote electronic device after the electronic document is transmitted from the sender's electronic device, is stored in the remote electronic device.

18. A method as recited in claim 14, wherein the step of determining the first identifier includes the step of:
transmitting at least a portion of digits contained in said electronic document being compiled in said sender's electronic device to said remote electronic certification device after a digit change occurs in said electronic document being compiled on said sender's electronic device, whereafter said remote electronic device then determines said first identifier based upon digits currently contained in said electronic document being compiled on said sender's electronic device.

19. A method as recited in claim 14 wherein the step of transmitting the electronic message from the sender's electronic device includes the step of a sender instructing the sender's electronic device to transmit the electronic document to the recipient's electronic device and the sender's electronic device transmits the electronic device to the database without instruction from the sender.

20. A method as recited in 14 wherein the step of determining the first identifier includes determining a third identifier representative of a second portion of the electronic document and storing the third identifier in the remote electronic device, the step of determining the second identifier includes the step of determining a fourth identifier representative of the second portion of the electronic document received on the recipient's electronic device, the step of determining if the second identifier is the same as the first identifier stored in the remote electronic device further includes the step of determining if the fourth identifier is the same as the third identifier stored in the remote electronic device, and the step of providing notification to the recipient's electronic device includes the step of providing said notification if the second and fourth identifiers are respectively the same as the first and third identifiers stored in the remote electronic device.

21. A method as recited in claim 20 wherein the electronic document contains at least a header portion containing addressing information and a body portion wherein the first portion of the electronic document corresponds to the header portion and the third portion of the electronic document corresponds to the body portion.

22. A method as recited in claim 21, wherein:
the first identifier is a checksum representative of said at least a portion of the header portion of the electronic document provided on the sender's electronic device;
the third identifier is a checksum representative of said at least a portion of the body portion of the electronic document provided on the sender's electronic device;
the second identifier is a checksum representative of said at least a portion of the header portion of the electronic document received on the recipients' electronic device; and
the fourth identifier is a checksum representative of said at least a portion of the body portion of the electronic document received on the recipients' electronic device.

23. A method as recited in claim 22, further including the steps of:
transmitting said at least a portion of the header portion of the electronic document being compiled on the sender's electronic device to the remote electronic device; and
transmitting said at least a portion of the body portion of the electronic document being compiled on the sender's electronic device to the remote electronic device; and
determining in said remote electronic device said first and third identifiers respectively based upon said transmitted header and body portion of said electronic document from said sender's electronic device.

24. A method as recited in claim 23, further including the steps of:
transmitting said at least a portion of the header portion of the electronic document on the recipient's electronic device to the remote electronic device;
transmitting said at least a portion of the body portion of the electronic document on the recipient's electronic device to the remote electronic device;
determining in said remote electronic device said second and fourth identifiers based upon said transmitted header and body portion of said electronic document from said recipient's electronic device; and
determining in said remote electronic device if the second and fourth identifiers are respectively the same as the first and third identifiers stored in the remote electronic device.

25. A method as recited in claim 24, further including the step of:
providing said copy of the electronic document stored in the remote electronic device to the recipient if it is determined that the second and fourth identifiers are determined not respectively the same as the first and third identifiers stored in the remote electronic device.

26. A method as recited in claim 24, further including the steps of:
determining the differences in the remote electronic device between the electronic document stored in the remote electronic device with that of the electronic document received by said recipient if the second and fourth identifiers are determined not respectively the same as the first and third identifiers stored in the remote electronic device; and
providing notification of the determined differences to the intended recipient.

27. A method as recited in claim 24, further including the step of a user located remote from said remote electronic device establishing electronic communication with said remote electronic device to selectively gain access to documents stored in said database.

28. A method for verifying the transmission of an electronic document that is transmitted from a sender's electronic device to a recipient's electronic device, said method comprising the steps of:
providing a remote electronic certification device remote from both said sender's and recipient's respective electronic devices;
establishing at least temporary communication between the sender's electronic device and the remote electronic certification device;
providing a link to said sender's electronic device from said remote electronic device associating said electronic document being compiled on said sender's electronic device with a file created in said remote electronic device for said electronic document being complied on said sender's electronic device;
embedding said link in said electronic document being compiled on said sender's electronic device;
transmitting the electronic document from the sender's electronic device to the recipient's electronic device and the remote electronic device wherein the sender instructs the sender's electronic device to transmit the electronic document to the recipient's electronic device and the sender's electronic device transmits the electronic device to the database without instruction from the sender;
receiving the electronic document at the recipient's electronic device and the remote electronic device;
storing the electronic document in the remote electronic device in association with the file created in said remote electronic device;
determining first identifying information representative of at least a portion of the electronic document transmitted from sender's electronic device to the recipient's electronic device;
storing in said remote electronic certification device the determined first identifying information;
establishing at least temporary communication between the recipient's electronic device and the remote electronic device via a said recipient activating said link embedded in said electronic document;
determining second identifying information in said remote electronic certification device that is representative of at least a portion of the electronic document received on the recipients' electronic device;
determining in said remote electronic certification device if said second identifying information is the same as said first identifying information stored in the remote electronic certification device;
providing certification from said remote electronic certification device for the electronic document transmitted to the recipient's electronic device if the second identifying information is determined the same as the first identifying information stored in the remote electronic device; and
establishing communication between a user of said remote electronic device with said remote electronic device for said user to selectively gain access to documents stored in said remote electronic device.

29. A method as recited in claim 28 wherein the electronic document consists of an e-mail message and the electronic device for each of the sender and recipient consist of a Personal Computer.

30. A method as recited in claim 28 wherein the step of determining the first identifying information includes determining a first identifier representative of a first portion of the electronic document and determining a second identifier representative of a second portion of the electronic document transmitted from said sender's electronic device and storing the first and second identifiers in the remote electronic device, the step of determining the second identifying information includes the step of a third identifier representative of a first portion of the electronic document received on the recipient's electronic device and determining a fourth identifier representative of a second portion of the electronic document received on the recipient's electronic device transmitted from said sender's electronic device, the step of determining if the second identifying information is the same as the first identifying information stored in the remote electronic device further includes the step of determining if the third and fourth identifiers are respectively the same as the first and second identifiers stored in the remote electronic device, and the step of providing notification to the recipient's electronic device includes the step of providing the notification if the third and fourth identifiers are respectively the same as the first and second identifiers stored in the remote electronic device.

31. A method as recited in claim 30 wherein the electronic document contains at least a header portion containing addressing information and a body portion wherein the first portion of the electronic document corresponds to the header portion and the third portion of the electronic document corresponds to the body portion.

32. A method as recited in claim 31, wherein:
the first identifier is a checksum representative of said at least a portion of the header portion of the electronic document provided on the sender's electronic device;
the second identifier is a checksum representative of said at least a portion of the body portion of the electronic document provided on the sender's electronic device;
the third identifier is a checksum representative of said at least a portion of the header portion of the electronic document received on the recipients' electronic device; and
the fourth identifier is a checksum representative of said at least a portion of the body portion of the electronic document received on the recipients' electronic device.

33. A method as recited in claim 32 further including the step of:
determining the first identifying information in the remote electronic device after the electronic document is transmitted from the sender's electronic device and stored in the remote electronic device.

34. A method as recited in claim 32 further including the step of:
determining the first identifying information in the remote electronic device after the electronic document is transmitted from the sender's electronic device and is stored in the remote electronic device and after the step of establishing temporary communication between the recipient's electronic device and the remote electronic device.

35. A method as recited in claim 32, wherein the step of determining the first identifying information includes the step of:
transmitting at least a portion of digits contained in said electronic document being compiled in said sender's electronic device to said remote electronic certification device after a digit change occurs in said electronic document being compiled on said sender's electronic device, whereafter said remote electronic device then determines said first identifying information based upon digits currently contained in said electronic document being compiled on said sender's electronic device.

36. A method as recited in claim 32, further including the steps of:
transmitting said at least a portion of the header portion of the electronic document on the recipient's electronic device to the remote electronic device;
transmitting said at least a portion of the body portion of the electronic document on the recipient's electronic device to the remote electronic device;
determining in said remote electronic device said third and fourth identifiers based upon said transmitted header and body portion of said electronic document received in said recipient's electronic device.

37. A method as recited in claim 28, further including the step of:
providing said copy of the electronic document stored in the remote electronic device to the recipient if it is determined that the second identifying information is not the same as the first identifying stored in the remote electronic device.

38. A method as recited in claim 28, further including the steps of:
determining the differences in the remote electronic device between the electronic document stored in the remote electronic device with that of the electronic document received by said recipient if the second identifying information is determined different than the first identifying information stored in the remote electronic device; and
providing notification of the determined differences to the intended recipient.
